(19) United States
(12) Patent Application Publication
(10) Pub. No.: US 2024/0388515 A1
(43) Pub. Date: Nov. 21, 2024

(54) INSPECTING GRADIENT BOOSTED TREES FOR NETWORK TROUBLESHOOTING AND APPLICATION OPTIMIZATION

(71) Applicant: Cisco Technology, Inc., San Jose, CA (US)

(72) Inventors: Grégory MERMOUD, Venthône (CH); Petar STUPAR, Lausanne (CH); Grégoire MAGENDIE, Lamorlaye (FR); Jean-Philippe VASSEUR, Combloux (FR)

(21) Appl. No.: 18/198,080

(22) Filed: May 16, 2023

(51) Int. Cl. H04L 41/147; H04L 41/22; H04L 43/08

(52) U.S. Cl. CPC H04L 43/08; G06N 5/01; G06N 20/00

(57) ABSTRACT

In one embodiment, a device obtains a plurality of telemetry metrics regarding an online application accessed via a network. The device trains, based on the plurality of telemetry metrics, a gradient boosted tree-based prediction model to make predictions regarding a quality of experience for the online application. The device quantifies how influential a particular telemetry metric is on the predictions. The device provides a visualization tool for display that indicates how influential the particular telemetry metric is on the predictions.

### TECHNICAL FIELD

The present disclosure relates generally to computer networks, and, more particularly, to inspecting gradient boosted trees for network troubleshooting and application optimization.

### BACKGROUND

With the recent evolution of machine learning, predictive failure detection and proactive routing in a network now becomes possible through the use of machine learning techniques. For instance, modeling the delay, jitter, packet loss, etc. for a network path can be used to predict when that path will violate the service level agreement (SLA) of the application and reroute the traffic, in advance. Recently, more complex models are able to predict the quality of experience (QoE) of an online application using feedback from the users of the application, instead of relying on SLA violations as a proxy for the QoE.

However, computer networks are complex systems and a prediction model may assess a large body of different metrics from the network and/or the online application, itself. This means that there are often multiple metrics that contribute to a given prediction, not just a singular factor, at any given time. Consequently, a network administrator or other interested party may have no insight as to why the prediction model made any given prediction, nor how to make long-term corrections.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for inspecting gradient boosted trees (GBTs) for network troubleshooting and application optimization;

FIGS. 6A-6D illustrate example displays of GBT-derived information by a visualization tool;

FIG. 7 illustrates an example display by the visualization tool showing where datapoints end up in a GBT per iteration;

FIG. 8 illustrates an example display by the visualization tool of decision boundaries;

FIG. 9 illustrates an example display of an option in the visualization tool to focus on common patterns or anomalous points; and

FIG. 10 illustrates an example simplified procedure for inspecting GBTs for network troubleshooting and application optimization.

### DESCRIPTION OF EXAMPLE EMBODIMENTS

Overview According to one or more embodiments of the disclosure, a device obtains a plurality of telemetry metrics regarding an online application accessed via a network. The device trains, based on the plurality of telemetry metrics, a gradient boosted tree-based prediction model to make predictions regarding a quality of experience for the online application. The device quantifies how influential a particular telemetry metric is on the predictions. The device provides a visualization tool for display that indicates how influential the particular telemetry metric is on the predictions.

### DESCRIPTION

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

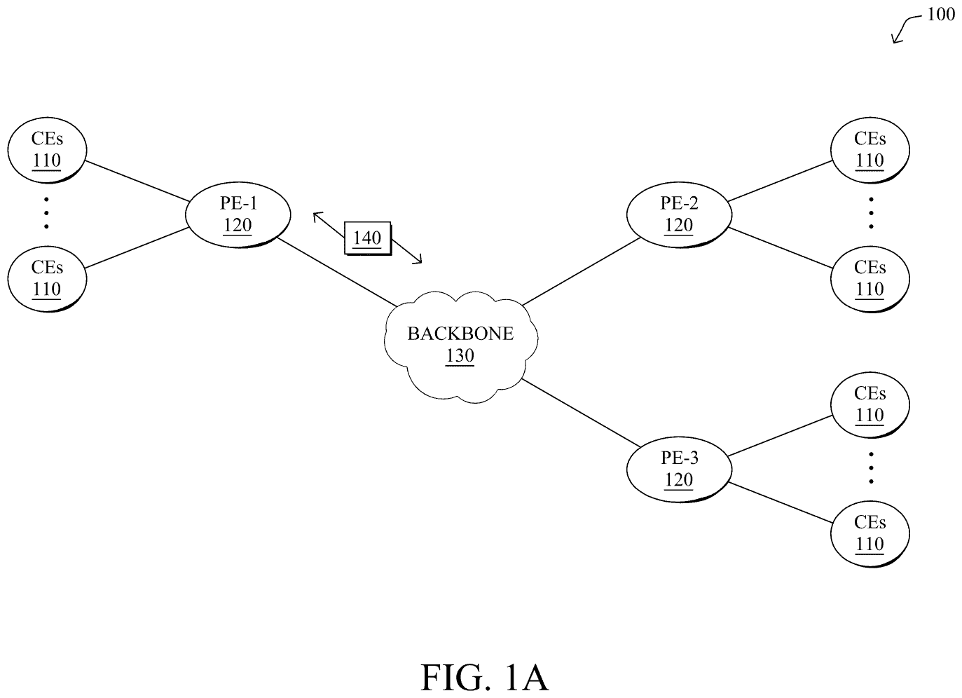

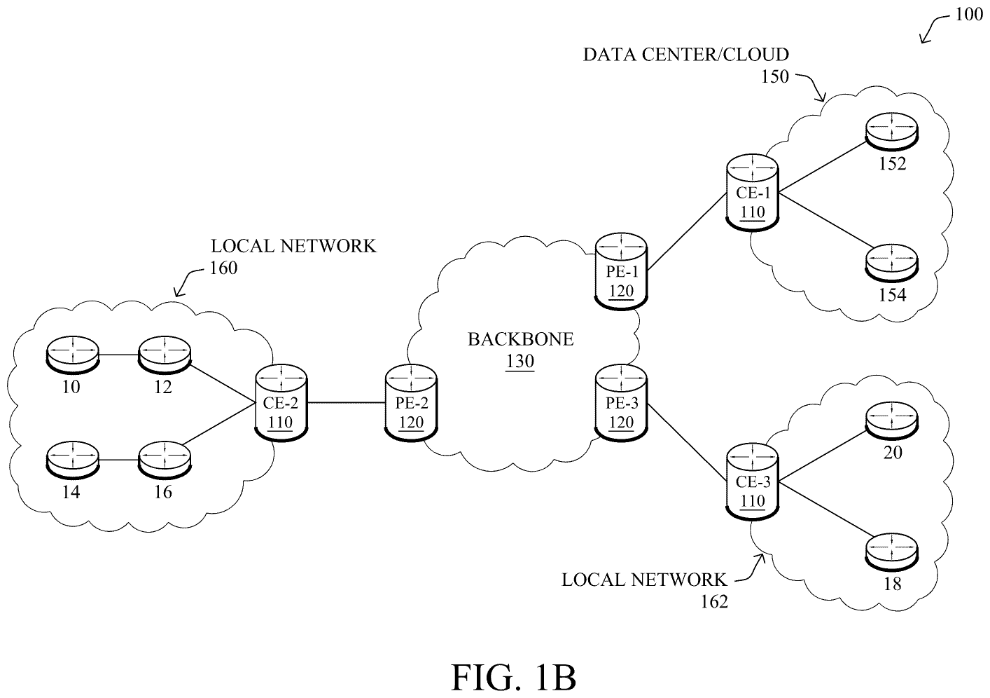

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:
1) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.
2) Site Type B: a site connected to the network by the CE router via two primary links (e.g., from different Service Providers), with potentially a backup link (e.g., a 3G/4G/5G/LTE connection). A site of type B may itself be of different types:
2a) Site Type B1: a site connected to the network using two MPLS VPN links (e.g., from different Service Providers), with potentially a backup link (e.g., a 3G/4G/5G/LTE connection).
2b) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.
2c) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).
3) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

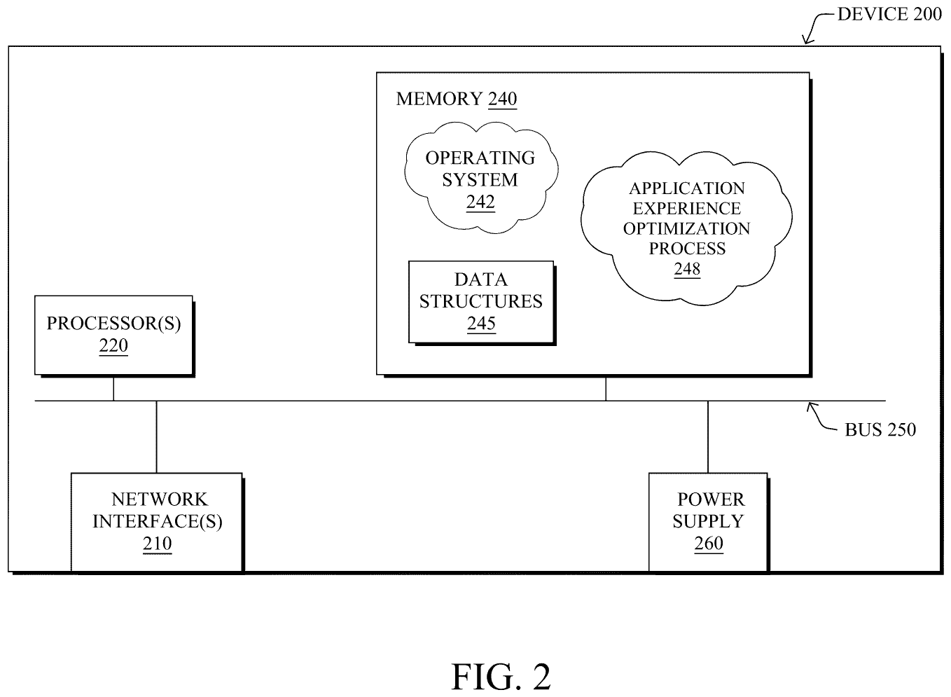

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise an application experience optimization process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, as detailed further below, application experience optimization process 248 may include computer executable instructions that, when executed by processor(s) 220, cause device 200 to perform the techniques described herein. To do so, in some embodiments, application experience optimization process 248 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, application experience optimization process 248 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that application experience optimization process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software-as-a-service (SaaS) is having a dramatic impact of the overall Internet due to the extreme virtualization of services and shift of traffic load in many large enterprises. Consequently, a branch office or a campus can trigger massive loads on the network.

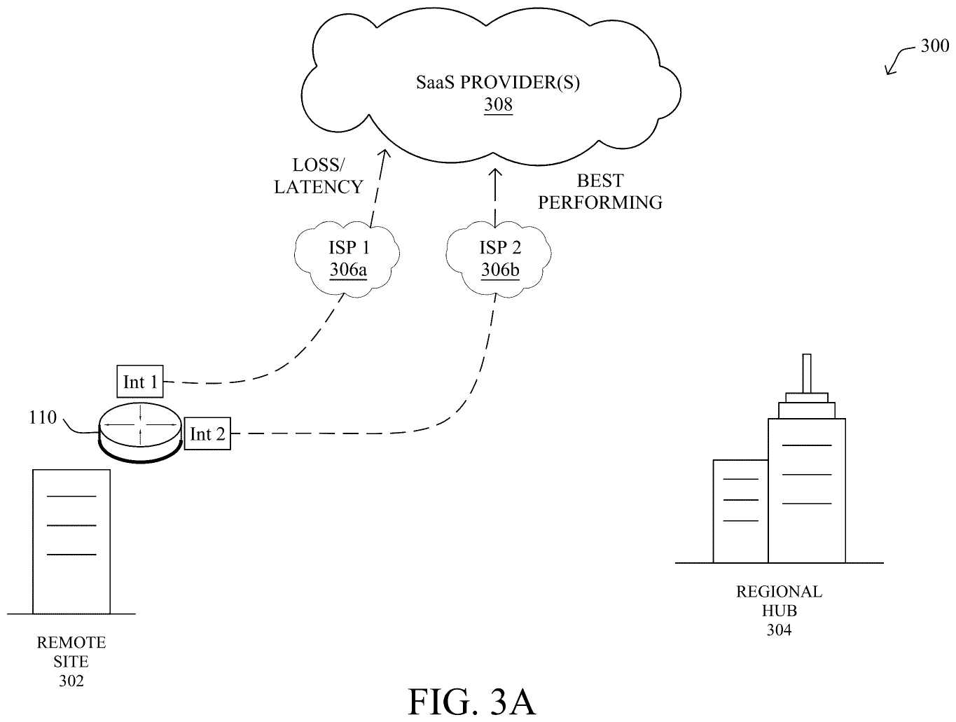

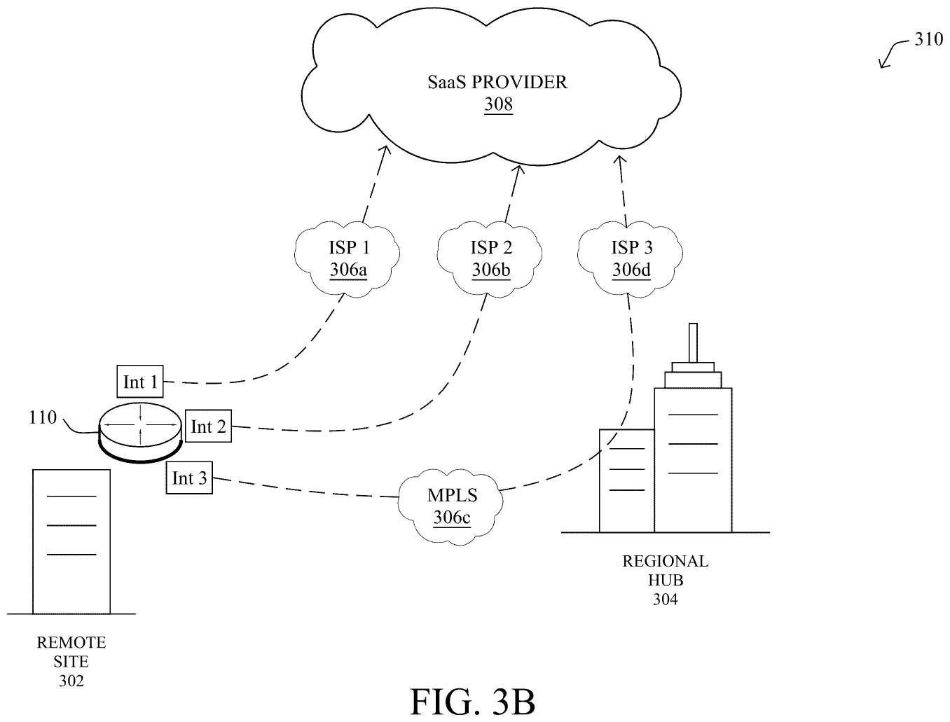

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and an SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g. public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

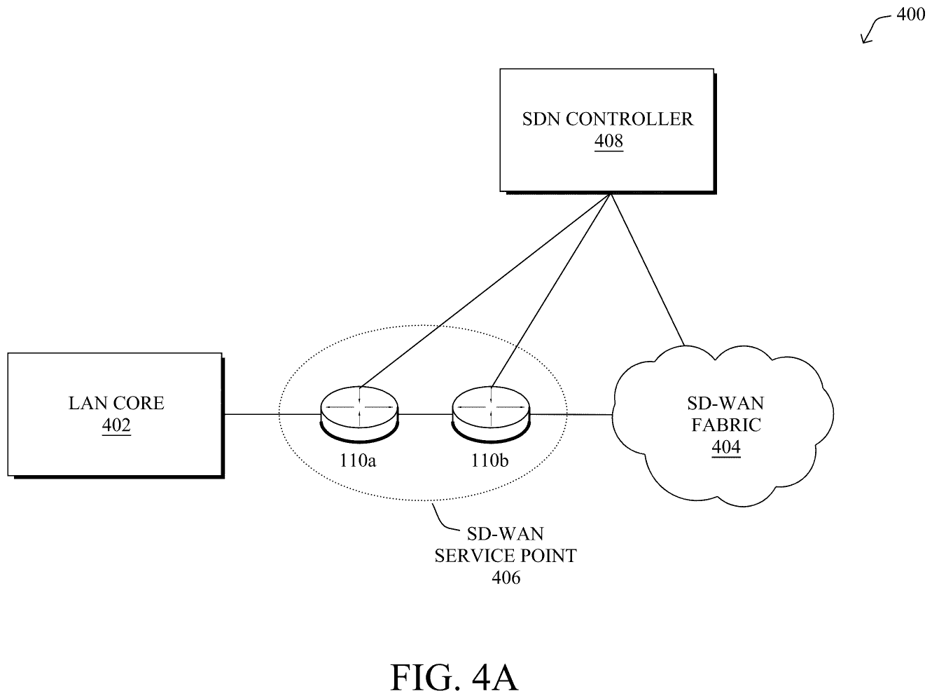

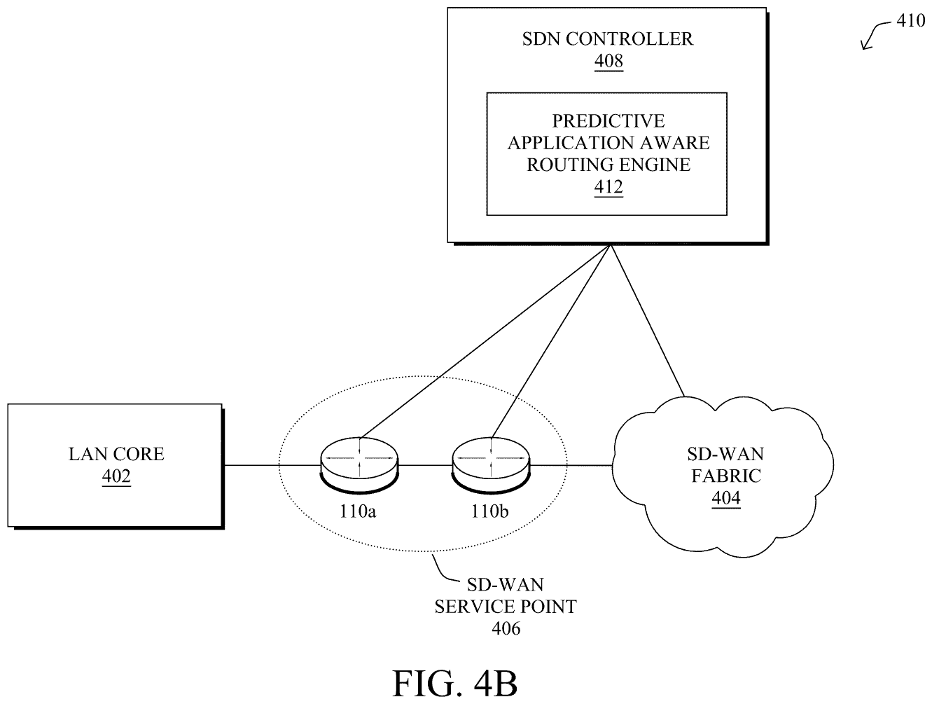

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging an SaaS model. Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing. CSPF, link state routing protocols (ISIS, OSPF, etc.) using various metrics (e.g. Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast with the notion of an informed decision.

SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of application experience optimization process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down tines. To that end, predictive application aware routing engine 412 may compute a variety of models to understand application requirements, and predictably route traffic over private networks and/or the Internet, thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In other words, predictive application aware routing engine 412 may use SLA violations as a proxy for actual QoE information (e.g., ratings by users of an online application regarding their perception of the application), unless such QoE information is available from the provider of the online application. In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, enterprise networks have undergone a fundamental transformation whereby users and applications have become increasingly distributed whereby technologies such as SD-WAN, Hybrid Work, and Zero Trust Network Access (ZTNA) have enabled unprecedented flexibility in terms of network architecture and underlay connectivity options. At the same time, collaboration applications, which are often critical for day-to-day business operations, have moved from on-premises deployment to a SaaS cloud delivery model that allows application vendors to rapidly deploy and take advantage of the latest and greatest codecs that can be used to increase robustness of media content.

In this highly dynamic environment, the ability of network administrators to understand the impact of network performance (or lack of) on the QoE of online applications, as well as ensuring that the proper SLAs are satisfied, is becoming increasingly challenging. Indeed, in years past, network metrics were used as a proxy for the true application QoE, with SLAs being set, accordingly. For instance, in the case of a voice application, the usual SLA boundaries are 150 ms for delay, 50 ms for jitter, and maximum of 3% packet loss. Today, such values are not as clear-cut. For example, two real-time voice calls may have different loss thresholds based on the audio codec being used whereby a voice application that uses a lossy codec such as Opus may be resistant until a packet loss of up to 30%, whereas other audio codecs, such as advanced audio coding (AAC), are usually not resilient to such high loss thresholds.

Another factor that demonstrates the shortfalls of relying on SLA thresholds as a proxy for the true application QoE is that SLAs are set without any consideration to the granularity of their underlying measurements. For instance, a path experiencing a constant delay of 120 ms for voice over a period of 10 minutes provides a very different user experience than a path with the same average delay that keeps varying between 20 and 450 ms, despite averaging out to the same over the time period. The dynamics of such metrics is even more critical for packet loss and jitter in the case of voice and video traffic (e.g. ten seconds of 80% packet loss would severely impact the user experience although averaged out over ten minutes would give a low value totally acceptable according to the threshold). Without a doubt, the user experience requires a more subtle and accurate approach in order to determine the networking requirements a path should meet in order to maximize the user satisfaction, capturing local phenomenon (e.g. effects on delay, jitter and loss at higher frequencies) but also telemetry from upper layers (applications).

Traditionally, a core principle of the Internet has been layer isolation. Such an approach allowed layer dependency (e.g. often referred to as layer violation) to be avoided, at a time where a number of protocols and technologies were developed at each layer. More specifically, the Open Systems Interconnection (OSI) model divides networks into seven networking layers:
1. The Physical (PHY) Layer—the layer representing the physical connections between devices
2. The Data Link Layer—e.g., the layer at which MAC addressing is used
3. The Network Layer—e.g., the layer at which the IP protocol is used
4. The Transport Layer—e.g., the layer at which TCP or UDP
5. The Session Layer—e.g., the layer at which a given session between endpoints is managed
6. The Presentation Layer—e.g., the layer that translates requests from the application layer to the session layer and vice-versa
7. The Application Layer—e.g., the highest layer at which the application itself operates

This allowed for the design and deployment of new layers (e.g. PHY, MAC, etc.) independent of each other, and allowing the Internet to scale. Still, with modern applications requiring tight SLAs, a cross-layer approach would be highly beneficial to optimizing the QoE of any given online application.

As noted above, computer networks are complex systems and a prediction model may assess a large body of different metrics from the network and/or the online application, itself. This means that there are often multiple metrics that contribute to a given prediction, not just a singular factor, at any given time. Indeed, it is often the case that many different aspects of the application pertain to the end user experience (e.g., for voice and video, the concealment time, buffers, frame rates, video resolution, client- and server-side CPU and memory, etc. can all affect the QoE). Consequently, a network administrator or other interested party may have no insight as to why the prediction model made any given prediction, nor how to make long-term corrections.

A key observation herein is that a Gradient Boosted Tree (GBT), which is a specialized form of machine learning decision trees, can provide some information that offers at least some insight into the factors affecting the predictions by the system.

### ——Inspecting GBTs for Network Troubleshooting and Application Optimization——

The techniques herein introduce a visualization tool that enables users to interpret the results of a gradient boosted tree (GBT)-based prediction model and gain insights that help them optimize their networks and applications. For instance, the visualization tool may show the data distribution in each node, the impact of each feature on the prediction, and/or the importance of each feature in terms of its effect on the positivity of the prediction.

Illustratively, the techniques described herein may be performed by hardware, software, and/or firmware, such as in application experience optimization process 248, which may include computer executable instructions executed by the processor 220 (or independent processor of interfaces 210) to perform functions relating to the techniques described herein.

Specifically, according to various embodiments, a device obtains a plurality of telemetry metrics regarding an online application accessed via a network. The device trains, based on the plurality of telemetry metrics, a gradient boosted tree-based prediction model to make predictions regarding a quality of experience for the online application. The device quantifies how influential a particular telemetry metric is on the predictions. The device provides a visualization tool for display that indicates how influential the particular telemetry metric is on the predictions.

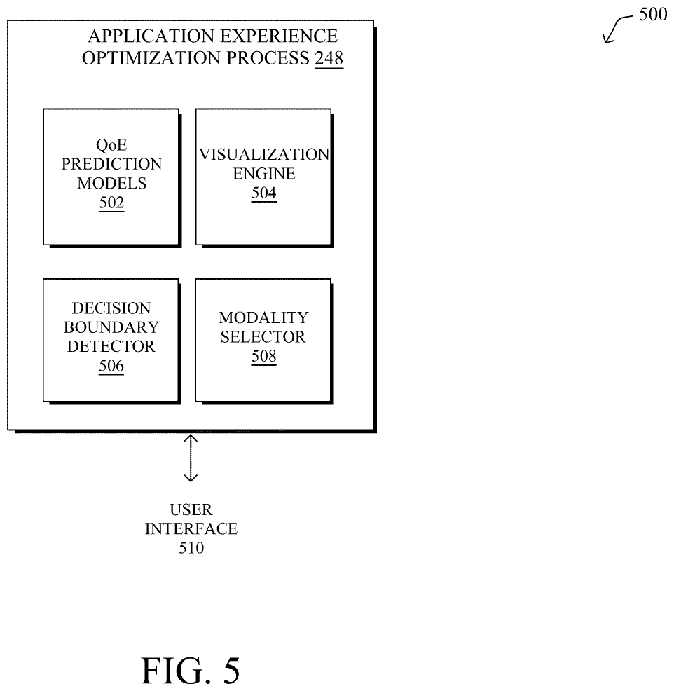

Operationally, FIG. 5 illustrates an example architecture for inspecting gradient boosted trees for network troubleshooting and application optimization, according to various embodiments. At the core of architecture 500 is application experience optimization process 248, which may be executed by a controller for a network, a networking device, or another device in communication therewith. For instance, application experience optimization process 248 may be executed by a controller for a network (e.g., SDN controller 408 in FIGS. 4A-4B), a particular networking device in the network (e.g., a router, etc.), another device or service in communication therewith, or any other device in a network. In some embodiments, for instance, application experience optimization process 248 may be used to implement a predictive application aware routing engine, such as predictive application aware routing engine 412, or another supervisory service for the network.

As shown, application experience optimization process 248 may include any or all of the following components: QoE prediction models 502, visualization engine 504, decision boundary detector 506, and/or modality selector 508. As would be appreciated, the functionalities of these components may be combined or omitted, as desired (e.g., implemented as part of application experience optimization process 248). In addition, these components may be implemented on a singular device or in a distributed manner, in which case the combination of executing devices can be viewed as their own singular device for purposes of executing application experience optimization process 248.

In various embodiments, QoE prediction models 502 comprises a collection of machine learning-based models trained to predict the QoE of one or more online applications. For instance, QoE prediction models 502 may be trained using actual user feedback (e.g., satisfaction ratings/scores) to predict the application QoE, given a rich body of cross-layer telemetry (e.g., L3 metrics such as delay, loss, jitter, bitrate, and L7 metrics such as concealment time, frame rates, jitter buffers, client CPU). These models, which do not use any a priori static formula, are an important step towards a more accurate and insightful understanding of what drives application user experience. QoE prediction models 502 may be useful to detect situations that lead to a poor experience for users of an application, relying on feedback from these users about their experience using the application at a given time. QoE prediction models 502 may also detect issues (e.g., situations in which users are unsatisfied with a high degree of confidence), make decisions (e.g., by comparing different situations and deciding which of them leads to higher user satisfaction), and possibly increase visibility (e.g., provide the overall predictions in an informative way).

As would be appreciated, a gradient boosted tree (GBT) falls under a class of machine learning-based decision trees that can be used to improve the predictive power of a simple model (called a weak learner, often a simple decision tree) by incrementally training models to refine the prediction of previous learners. In each iteration of the decision tree, the values of the coefficients, weights, or biases applied to the input variables used to predict the target value are adjusted with the objective of reducing the loss function, which measures the difference between the predicted and actual target values. The gradient, which represents the incremental modification made at each step, is utilized to accelerate the improvement in predictive accuracy until an optimal value is achieved. Boosting is the technique employed to accomplish this acceleration.

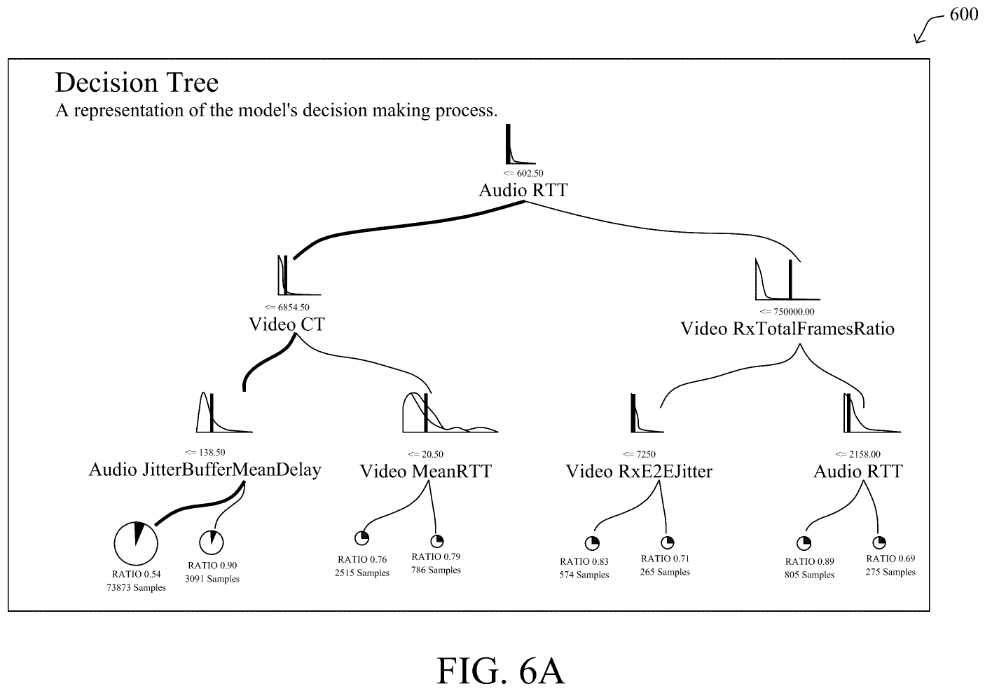

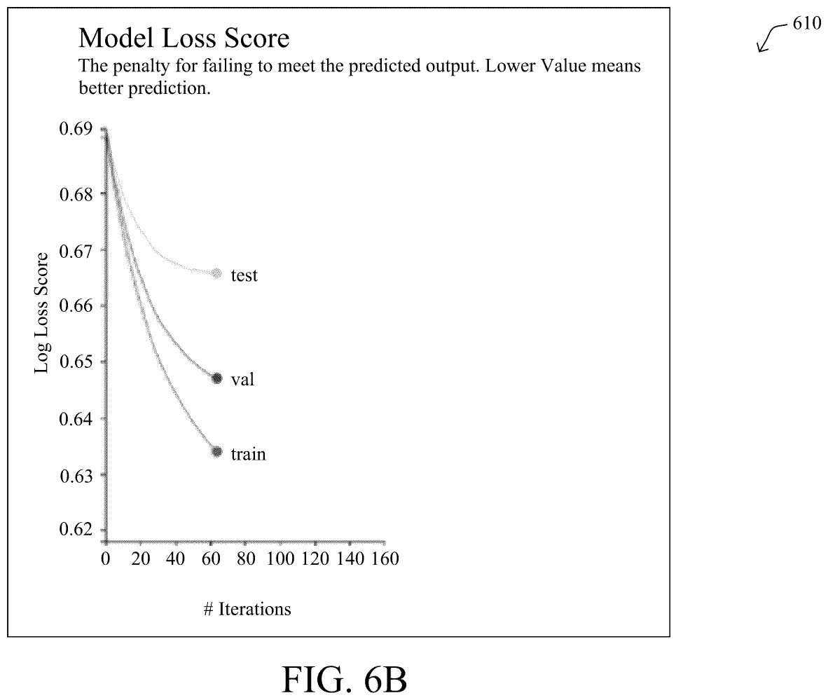

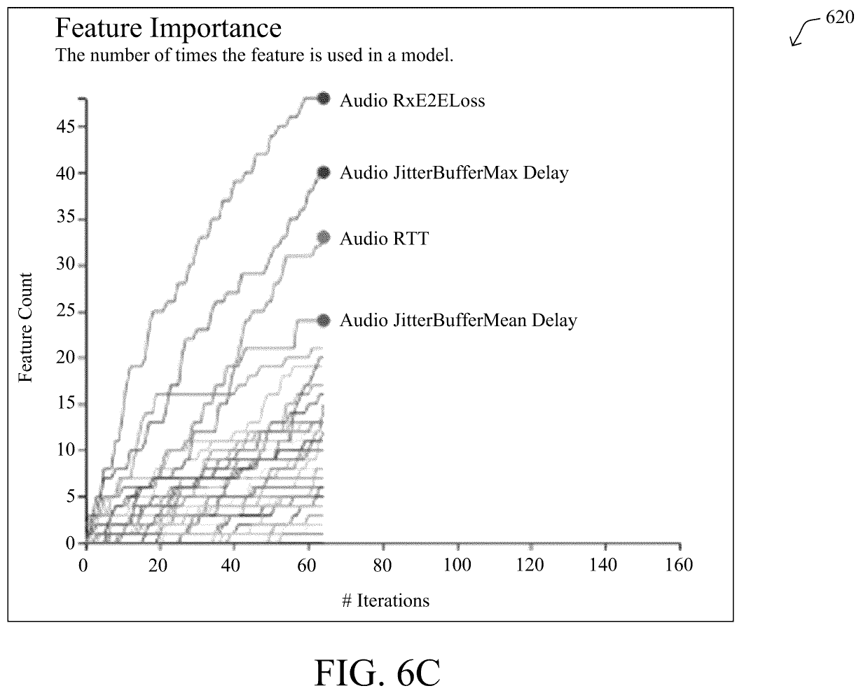

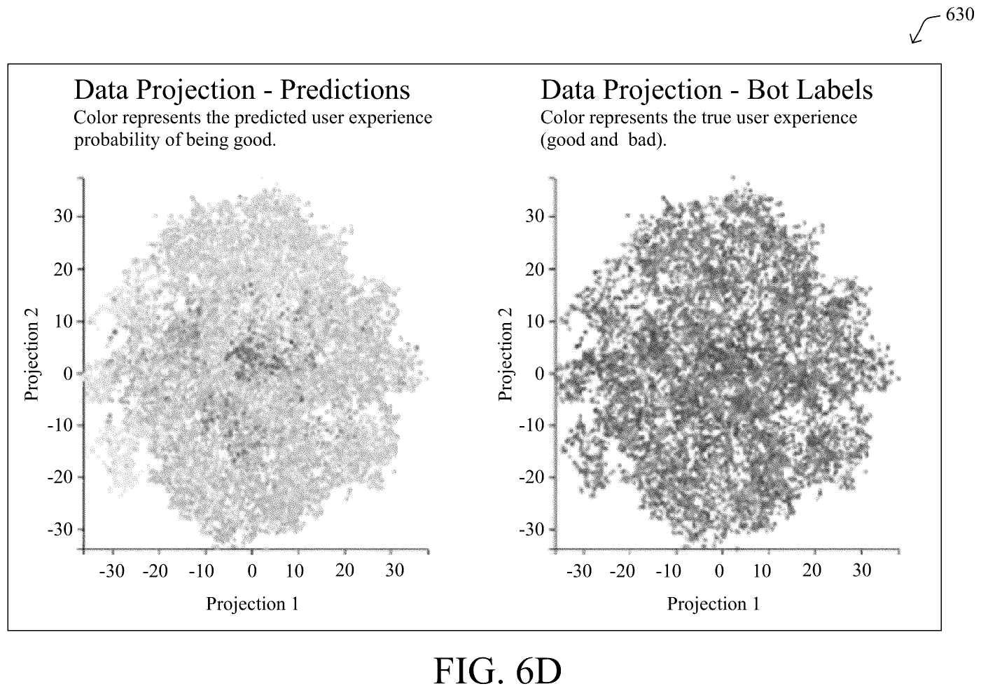

According to various embodiments, visualization engine 504 may take the form of a visualization tool that shows different iterations of a QoE model from QoE prediction models 502, based on GBT and highlights different views to a user. For instance, FIGS. 6A-6D show different views 600-630, respectively, that visualization engine 504 may provide to user interface 510 for display. More specifically, FIG. 6A illustrates an example display 600 of a decision tree, thereby allowing the user of user interface 510 to view the decision making of the model with respect to the different telemetry metrics that influenced these decisions, such as audio round trip time (RTT), video concealment time (CT), audio jitter buffer mean delay, video receive total frames ratio, video receive end-to-end (E2E) jitter, and audio RTT.

FIG. 6B illustrates an example display 610 of the model loss score as a function of the number of iterations. Here, the lower the loss score (or log of the loss score, as shown) means better predictions by the model.

FIG. 6C illustrates an example display 620 showing a plot of the importance of different features (i.e., the input telemetry metrics to the prediction model) on its predictions. As can be seen, the audio receive E2E loss metric is the most influential on the predictions, followed by the audio jitter buffer max delay metric, followed by the audio RTT, followed by the audio jitter buffer mean delay metric, followed by the other metrics/features evaluated by the prediction model.

FIG. 6D illustrates an example display 630 showing the data projections, to represent the most important relationships between data points. Here, each point in the projection may also be colored to represent the true label of the target variable.

More specifically, there may be up to three, or even more, distinct use cases for the visualization tool displayed by visualization engine 504:
Use case 1 (application designer): In this situation, the system may train the QoE prediction model either offline (e.g., using Mechanical Turk for labels) or online (e.g., by relying on feedback from real users for the labels) for a new application or a new version of an existing application (e.g., a new codec for a videoconferencing application). The application is provided to a cohort of beta testers, which provide ratings about their experience (thumbs up or down, 1-5 ratings, etc.). The application designer then uses the tool to understand how the application withstands different network impairments and how the user experience can be improved.
Use case 2 (network owner): In this case, the system may pre-train the model on user labels previously collected, but it can also be “refined” or trained from scratch on labels obtained from users of the network. The network owner can then use the visualization tool provided by visualization engine 504 to understand what are the key factors that drive the poor experience of its users.
Use case 3 (end user): In this case, the underlying model is the same as the one used by the network owner, but end users may access the visualization tool to view a reduced set of data that only concerns their own sessions. This provides some visibility into issues that might occur on the access layer (e.g., Wi-Fi) or on the device (e.g., high CPU, low memory), allowing the end user to trouble shoot certain issues.

Given that the GBT is an iterative machine learning algorithm that leverages a sequence of weak models, each iteration, or boosting round, of the algorithm adds a new tree to the ensemble, which improves the overall accuracy of the model. The contribution of each tree depends on its structure, decisions, and thresholds, which determine how the model assigns weights to the input features. Visualizing the trees at each iteration can provide insights into how the model is learning and improving over time, such as via display 600 in FIG. 6A. It can also help identify the most important decisive splits in terms of impact on positivity. Each node may also show the kernel density estimation (KDE) of data points that end up on it, colored by labels (e.g., by coloring positive as green and negative as red). Users can inspect the distribution of data in each node and see the impact of each feature split. Visualization engine 504 may also represent the final nodes (i.e., the leaf nodes) with pie charts showing the ratio of positive and negative samples that end up there. Visualization engine 504 may also identify and display the most important splits in terms of impact on positivity, allowing users to identify regions where positivity is different and learn the KPI thresholds to make better decisions.

The evolution of the model loss score of the model, which visualization engine 504 may display via display 610 in FIG. 6B, is a measure of how well the model is performing during the training process. In each iteration of the GBT, the loss score is calculated by comparing the predicted values with the actual target values for the training data. Here, the goal is to minimize the loss score, which indicates how far off the predictions are from the actual values.

During the GBT training process, the system may also calculate the feature importance (a measure of the contribution of each input feature to the overall performance of the model) for each iteration of boosting. At each iteration, the model learns to emphasize the features (KPIs) that are most informative for predicting the target variable. By measuring feature importance at each iteration, which visualization engine 504 may display via display 620 in FIG. 6C, the user of user interface 510 can gain insights into how the relative importance of each feature evolves as the model learns. More specifically, that user can evaluate the feature importance values to identify which features are most valuable for predicting the target variable, and which features are less important or redundant. To this end, visualization engine 504 may generate display data plotting or otherwise showing the importance scores, to allow the user of user interface 510 to better understand the evolution of feature importance throughout the training process.

Finally, to generate display 630 in FIG. 6D, visualization engine 504 may perform dimensionality reduction, such as Principal Component Analysis (PCA) or t-SNE, on the telemetry metrics, to preserve the most important relationships between the data points in a lower-dimensional space. Once visualization engine 504 has obtained the 2D projection, it may also color each point according to the true label of the target variable (e.g., green for positive cases and red for negative cases on one side of the visualization) and the continuous value predicted by the GBT model on the other side (e.g., a color gradient from red to green for low to high predicted values). This visualization can help the user of user interface 510 to identify patterns and correlations between the input features, the target variable, and the GBT model's predictions. It can also highlight potential outliers or anomalies in the data, as well as provide a general understanding of the model's overall performance.

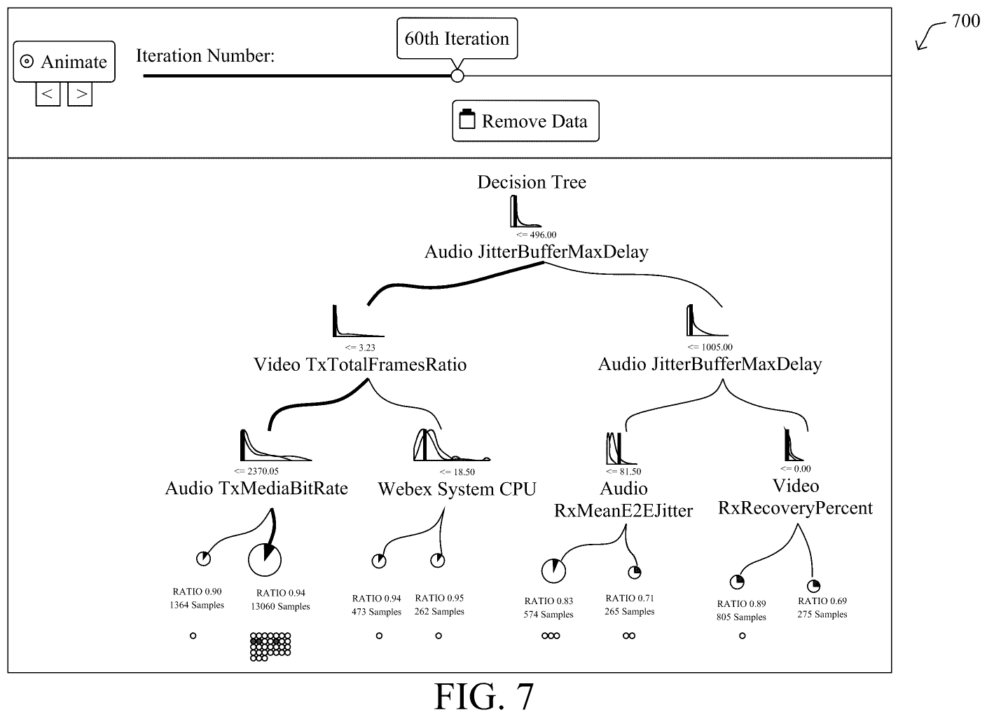

In further embodiments, visualization engine 504 may also provide a tool to user interface 510 that allows its user to inspect custom-chosen data points and where they end up in a decision tree per iteration. By way of example, display 700 in FIG. 7 shows a representation of this. Here, the user may troubleshoot network and application performance issues, by selecting a specific set of data points/metrics. For instance, network administrators, application designers, or end users can select a few 1-minute reports, reports from one site, or reports from one user, and use the visualization tool to understand how they are processed by the tree.

By analyzing these specific points, it is possible to identify the root causes of network or application issues and potential areas for improvement. For example, if a particular user is experiencing poor application performance, slicing the data to focus on their reports can help identify if the issue is related to their device, network connection, or the application itself. Similarly, if reports from one site consistently show degraded performance, analyzing these reports can help identify network bottlenecks or configuration issues that are affecting that site. Slicing specific data points and using the visualization tool can provide valuable insights for troubleshooting and optimizing network and application performance.

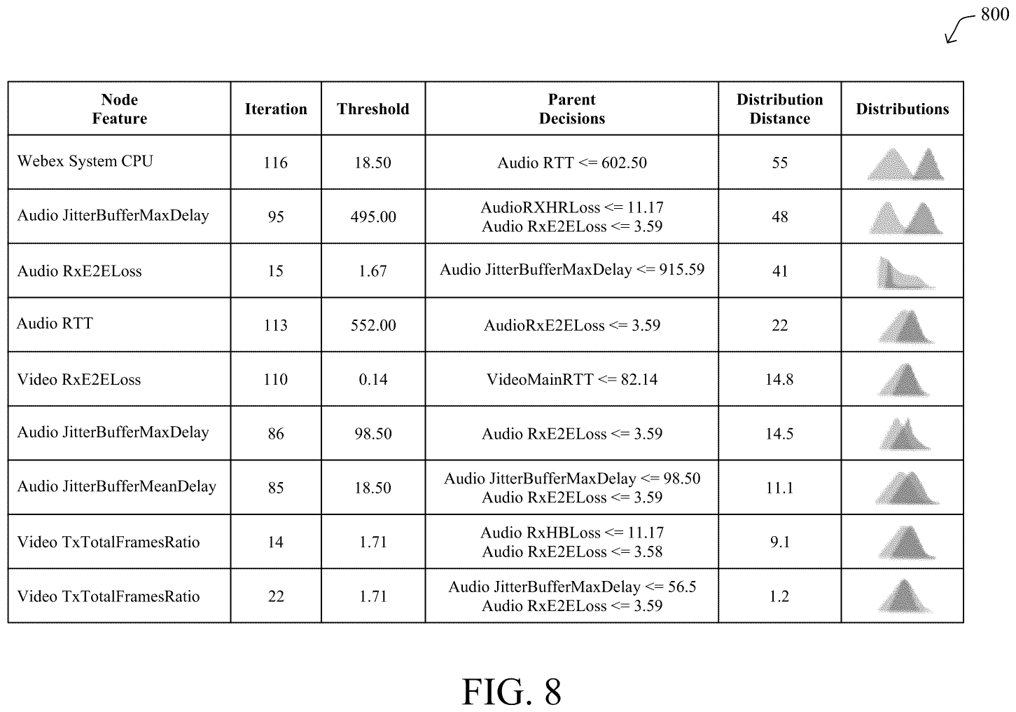

In various embodiments, decision boundary detector 506 may be configured to automatically detect the most interesting decision boundaries of the GBT by computing statistical distance (e.g., Kolmogorov-Smirnov) between the KPI distribution of the positive and the negative samples at each node. If the two distributions are far apart, a simple threshold applied to the KPI can separate the positive from the negative samples. This means that all the parent splits that led to the node delineated a telemetry regime where one KPI value can drastically impact the QoE of the user when it crosses a certain threshold. In turn, visualization engine 504 may provide a display of the results to user interface 510 for display. For instance, example display 800 in FIG. 8 illustrates an example of such information, allowing the user to review the node feature (i.e., telemetry metric), number of iterations, threshold, parent decision in the decision tree, distribution distance, a graphical representation of the distributions, or the like.

In some instances, display 800 may also allow the user of user interface 510 to rank the nodes by descending distances and select a specific node to visualize the parent splits that led to it. This provides a simple tool to pinpoint the interesting regimes where a single KPI has a huge impact (e.g., when the jitter is between A and B and the loss is between C and D then the QoE is good if the latency is lower than X and bad otherwise), offering great insight into the application failure modes.

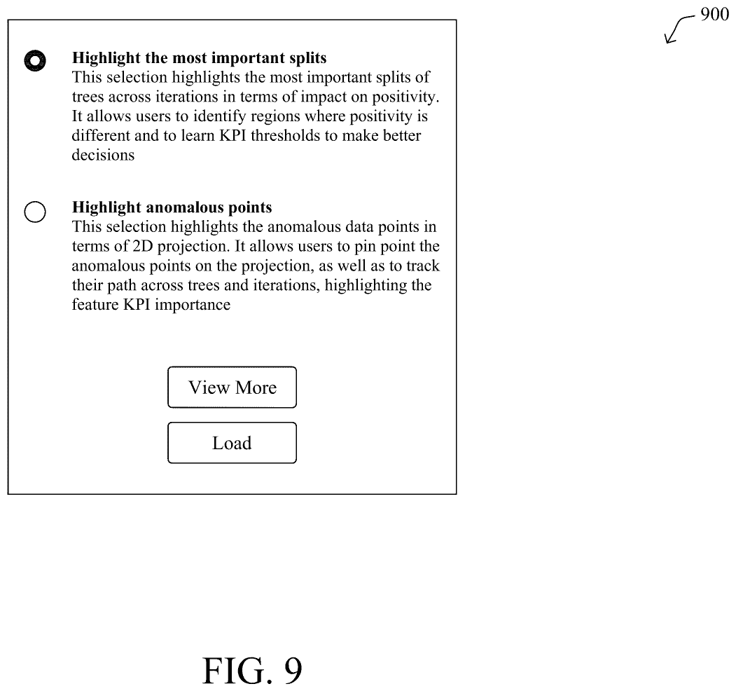

In various embodiments, modality selector 508 may allow the user of user interface 510 to select the modality of the visualization, allowing them to focus on what matters most to them and their investigation. More specifically, modality selector 508 may operate in conjunction with visualization engine 504 to present the user of user interface 510 with several options that would automatically adjust the visualization and all charts within it, according to the selection. For instance, a user might want to see all the most important splits highlighted right away to learn the KPI thresholds and make fast decisions. By way of example, display 900 in FIG. 9 demonstrates such an option, letting the user to select between highlighting the most important decision splits or instead highlighting the anomalous points, instead.

As would be appreciated, the visualization tools afforded by application experience optimization process 248 allows users to inspect the data distribution in each node and gain insights into the underlying data that influence the prediction. In addition, users can visualize the impact of each feature on the prediction and identify the most important features that affect the positivity of the prediction. Further, the users can utilize the visualization tool to troubleshoot issues and/or optimize the application (or network) by inspecting what the GBT has learned. Further, the tool is easy to use and requires no technical expertise in machine learning.

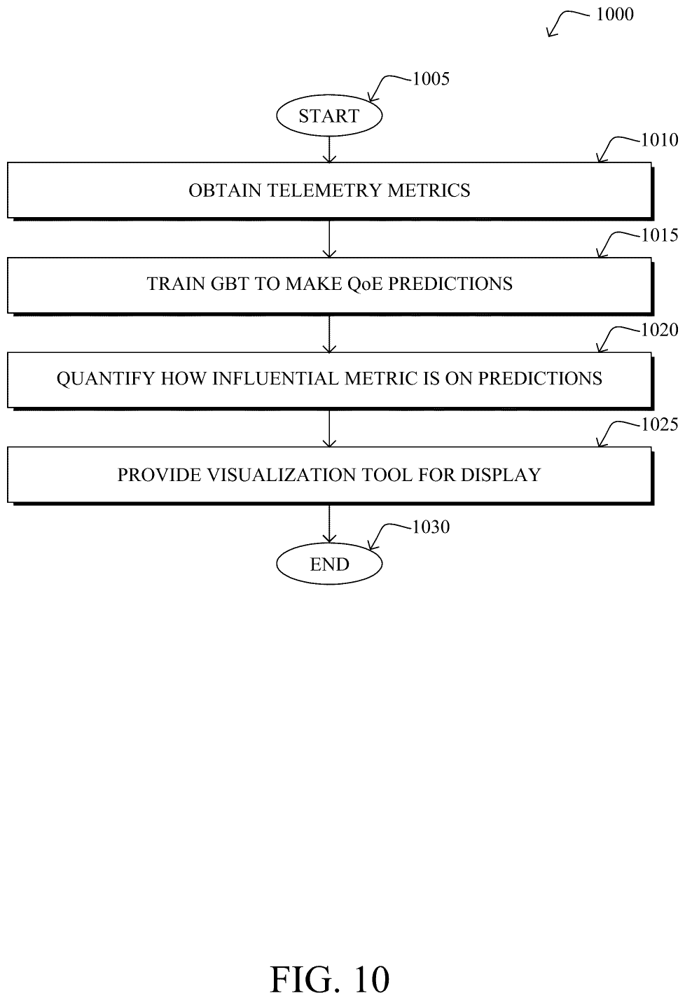

FIG. 10 illustrates an example simplified procedure for inspecting gradient boosted trees for network troubleshooting and application optimization, in accordance with one or more embodiments described herein. For example, a non-generic, specifically configured device (e.g., device 200), such as controller for a network (e.g., an SDN controller, a cloud-based device, etc.), an edge router, or other device in communication with a network, may perform procedure 1000 by executing stored instructions (e.g., application experience optimization process 248). The procedure 1000 may start at step 1005, and continues to step 1010, where, as described in greater detail above, the device may obtain a plurality of telemetry metrics regarding an online application accessed via a network.

At step 1015, as detailed above, the device may train, based on the plurality of telemetry metrics, a gradient boosted tree-based prediction model to make predictions regarding a quality of experience for the online application. In some embodiments, the device may train the gradient boosted tree-based prediction model using quality of experience feedback provided by users of the online application (e.g., based on satisfaction ratings for the online application).

At step 1020, the device may quantify how influential a particular telemetry metric is on the predictions, as described in greater detail above. In some embodiments, the particular telemetry metric is a Layer-3 metric captured by the network (e.g., delay, loss, jitter, etc.). In further embodiments, the particular telemetry metric is a Layer-7 metric computed by the online application (e.g., concealment time, buffer metric, frame rate, video resolution, etc.).

At step 1025, as detailed above, the device may provide a visualization tool for display that indicates how influential the particular telemetry metric is on the predictions. In some embodiments, the device may do so by providing a representation of a decision split in the gradient boosted tree-based prediction model that is contingent on the particular telemetry metric for display by the visualization tool. In another embodiment, the device may do so by providing distributions of positive and negative samples of the particular telemetry metric for display by the visualization tool. In a further embodiment, the device may also provide an indication of a threshold for the particular telemetry metric for display by the visualization tool at which a change occurs in the predictions. In another embodiment, the device may also provide a dimensionality reduction between the particular telemetry metric and another metric for display by the visualization tool. In an additional embodiment, the device may also control the visualization tool to highlight anomalous data points in the plurality of telemetry metrics, based on a parameter set by a user of the visualization tool. In a further embodiment, the device may also provide an indication of a loss function associated with the gradient boosted tree-based prediction model for display by the visualization tool.

Procedure 1000 then ends at step 1030.

It should be noted that while certain steps within procedure 1000 may be optional as described above, the steps shown in FIG. 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for inspecting gradient boosted trees for network troubleshooting and application optimization, it is to be understood that various other adaptations and modifications may be made within the spirit and scope of the embodiments herein. For example, while certain embodiments are described herein with respect to using certain models for purposes of predicting application experience metrics, application QoE, disruptions in a network, etc., the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, a plurality of telemetry metrics regarding an online application accessed via a network;
training, by the device and based on the plurality of telemetry metrics, a gradient boosted tree-based prediction model to make predictions regarding a quality of experience for the online application;
quantifying, by the device, how influential a particular telemetry metric is on the predictions; and
providing, by the device, a visualization tool for display that indicates how influential the particular telemetry metric is on the predictions.

2. The method as in claim 1, wherein the particular telemetry metric is a Layer-3 metric captured by the network.

3. The method as in claim 1, wherein the particular telemetry metric is a Layer-7 metric computed by the online application.

4. The method as in claim 1, further comprising:
providing an indication of a threshold for the particular telemetry metric for display by the visualization tool at which a change occurs in the predictions.

5. The method as in claim 1, wherein providing the visualization tool for display that indicates how influential the particular telemetry metric is on the predictions comprises:
providing a representation of a decision split in the gradient boosted tree-based prediction model that is contingent on the particular telemetry metric for display by the visualization tool.

6. The method as in claim 1, wherein providing the visualization tool for display that indicates how influential the particular telemetry metric is on the predictions comprises:
providing distributions of positive and negative samples of the particular telemetry metric for display by the visualization tool.

7. The method as in claim 1, further comprising:
providing a dimensionality reduction between the particular telemetry metric and another metric for display by the visualization tool.

8. The method as in claim 1, wherein the device trains the gradient boosted tree-based prediction model using quality of experience feedback provided by users of the online application.

9. The method as in claim 1, further comprising:
controlling the visualization tool to highlight anomalous data points in the plurality of telemetry metrics, based on a parameter set by a user of the visualization tool.

10. The method as in claim 1, further comprising:
providing an indication of a loss function associated with the gradient boosted tree-based prediction model for display by the visualization tool.

11. An apparatus, comprising:
one or more network interfaces;
a processor coupled to the one or more network interfaces and configured to execute one or more processes; and
a memory configured to store a process that is executable by the processor, the process when executed configured to:
obtain a plurality of telemetry metrics regarding an online application accessed via a network;
train, based on the plurality of telemetry metrics, a gradient boosted tree-based prediction model to make predictions regarding a quality of experience for the online application;
quantify how influential a particular telemetry metric is on the predictions; and
provide a visualization tool for display that indicates how influential the particular telemetry metric is on the predictions.

12. The apparatus as in claim 11, wherein the particular telemetry metric is a Layer-3 metric captured by the network.

13. The apparatus as in claim 11, wherein the particular telemetry metric is a Layer-7 metric computed by the online application.

14. The apparatus as in claim 11, wherein the process when executed is further configured to:
provide an indication of a threshold for the particular telemetry metric for display by the visualization tool at which a change occurs in the predictions.

15. The apparatus as in claim 11, wherein the apparatus provides the visualization tool for display that indicates how influential the particular telemetry metric is on the predictions by:
providing a representation of a decision split in the gradient boosted tree-based prediction model that is contingent on the particular telemetry metric for display by the visualization tool.

16. The apparatus as in claim 11, wherein the apparatus provides the visualization tool for display that indicates how influential the particular telemetry metric is on the predictions by:
providing distributions of positive and negative samples of the particular telemetry metric for display by the visualization tool.

17. The apparatus as in claim 11, wherein the process when executed is further configured to:
provide a dimensionality reduction between the particular telemetry metric and another metric for display by the visualization tool.

18. The apparatus as in claim 11, wherein the apparatus trains the gradient boosted tree-based prediction model using quality of experience feedback provided by users of the online application.

19. The apparatus as in claim 11, wherein the process when executed is further configured to:
control the visualization tool to highlight anomalous data points in the plurality of telemetry metrics, based on a parameter set by a user of the visualization tool.

20. A tangible, non-transitory, computer-readable medium storing program instructions that cause a device to execute a process comprising:
obtaining, by a device, a plurality of telemetry metrics regarding an online application accessed via a network;
training, by the device and based on the plurality of telemetry metrics, a gradient boosted tree-based prediction model to make predictions regarding a quality of experience for the online application;
quantifying, by the device, how influential a particular telemetry metric is on the predictions; and
providing, by the device, a visualization tool for display that indicates how influential the particular telemetry metric is on the predictions.
